(19) United States
(12) Patent Application Publication
(10) Pub. No.: US 2017/0214122 A1
(43) Pub. Date: Jul. 27, 2017

(54) MOBILE COMMUNICATION DEVICE

(71) Applicant: AUDEN TECHNO CORP., TAOYUAN COUNTY (TW)

(72) Inventor: CHI-MING CHIANG, Taoyuan County (TW)

(21) Appl. No.: 15/004,075

(22) Filed: Jan. 22, 2016

(51) Int. Cl. H01Q 1/24; H01Q 9/04

(52) U.S. Cl. CPC H01Q 1/243; H01Q 9/04

(57) ABSTRACT

A mobile communication device includes an assembly, an antenna module disposed on the assembly, and a metal cover detachably fixed on the assembly. The antenna module has an internal segment and an external segment connected to the internal segment. The internal segment is arranged in a space surrounded by the metal cover and the assembly and is entirely shielded by the metal cover in a thickness direction. The external segment is disposed on a short side surface of the assembly and is arranged outside the space. The external segment does not contact the metal cover. Thus, the metal cover of the mobile communication device of the instant disclosure can be provided without extra design.

### BACKGROUND OF THE INVENTION

1. Field of the Invention

The instant invention relates to a communication device; in particular, to a mobile communication device.

2. Description of Related Art

The metal cover of conventional communication devices is provided with at least one slot, corresponding to an antenna module of the conventional communication device, and at least one mating hole, corresponding to a functional component (e.g., camera or connector) of the conventional communication device. The slot of the metal cover is configured to be a resonator for the antenna module, thereby preventing the antenna module from being entirely shielded by the metal cover. However, the metal cover needs to be processed to form the slot, and the slot of the metal cover needs to be filled with a plastic material for maintaining the appearance of the metal cover.

### SUMMARY OF THE INVENTION

The instant disclosure provides a mobile communication device for effectively improving the problem generated by the conventional communication device.

The instant disclosure provides a mobile communication device, comprising: an assembly, comprising a frame having a front surface, a rear surface, two long side surfaces, and two short side surfaces, wherein the two long side surfaces and the two short side surfaces are connected to a peripheral edge of the front surface, the frame defines a thickness direction perpendicular to the front surface; and a circuit board disposed on the frame, wherein the frame has a mounting region arranged between the circuit board and one of the two short side surfaces; an antenna module disposed on the frame and electrically connected to the circuit board, the antenna module comprising: a high frequency antenna having a high frequency internal segment and a high frequency external segment connected to the high frequency internal segment, wherein the high frequency internal segment is disposed on the mounting region, and the high frequency external segment is disposed on the one of the short side surfaces arranged adjacent to the mounting region; and a low frequency antenna having a low frequency internal segment and a low frequency external segment connected to the low frequency internal segment, wherein the low frequency internal segment is disposed on the mounting region, and the low frequency external segment is disposed on the one of the short side surfaces arranged adjacent to the mounting region; and a metal cover detachably fixed on the frame of the assembly, wherein the high frequency internal segment and the low frequency internal segment of the antenna module are arranged in a space surrounded by the metal cover and the frame, the high frequency internal segment and the low frequency internal segment are shielded by the metal cover in the thickness direction, the high frequency external segment and the low frequency external segment of the antenna module are arranged outside the space surrounded by the metal cover and the frame, and the high frequency external segment and the low frequency external segment do not contact the metal cover.

The instant disclosure also provides a mobile communication device, comprising: an assembly, comprising: a frame having a front surface, a rear surface, two long side surfaces, and two short side surfaces, wherein the two long side surfaces and the two short side surfaces are connected to a peripheral edge of the front surface, the frame defines a thickness direction perpendicular to the front surface; and a circuit board disposed on the frame, wherein the frame has a mounting region arranged between the circuit board and one of the two short side surfaces; and an antenna module disposed on the frame and electrically connected to the circuit board, the antenna module comprising: a high frequency antenna having a high frequency internal segment and a high frequency external segment connected to the high frequency internal segment, wherein the high frequency internal segment is disposed on the mounting region, and the high frequency external segment is disposed on the one of the short side surfaces arranged adjacent to the mounting region; and a low frequency antenna having a low frequency internal segment and a low frequency external segment connected to the low frequency internal segment, wherein the low frequency internal segment is disposed on the mounting region, and the low frequency external segment is disposed on the one of the short side surfaces arranged adjacent to the mounting region.

In summary, the mobile communication device of the instant embodiment is provided with the high frequency external segment and the low frequency external segment, which are disposed on the short side surface, for receiving or emitting signal, thus the antenna module can be normally operated and the metal cover can be provided without any slot or hole related to the antenna module.

In order to further appreciate the characteristics and technical contents of the instant invention, references are hereunder made to the detailed descriptions and appended drawings in connection with the instant invention. However, the appended drawings are merely shown for exemplary purposes, rather than being used to restrict the scope of the instant invention.

### BRIEF DESCRIPTION OF THE DRAWINGS

FIG. 1 is a perspective view showing a mobile communication device according to the instant disclosure;

FIG. 2 is a perspective view of FIG. 1 from another perspective;

FIG. 3 is an exploded view of FIG. 2; and

FIG. 4 is an enlarged view showing the portion A of FIG. 3.

### DETAILED DESCRIPTION OF THE PREFERRED EMBODIMENTS

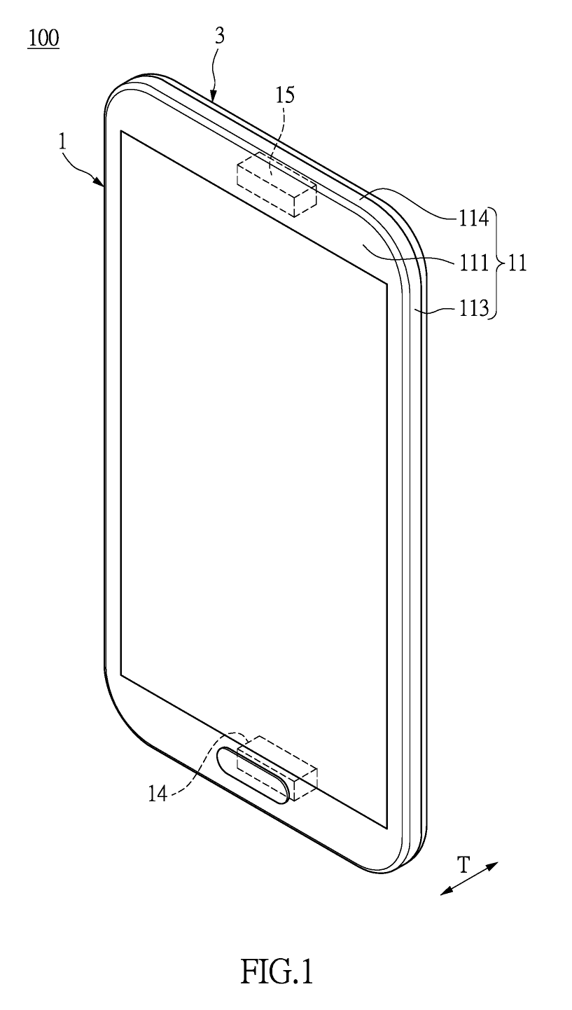

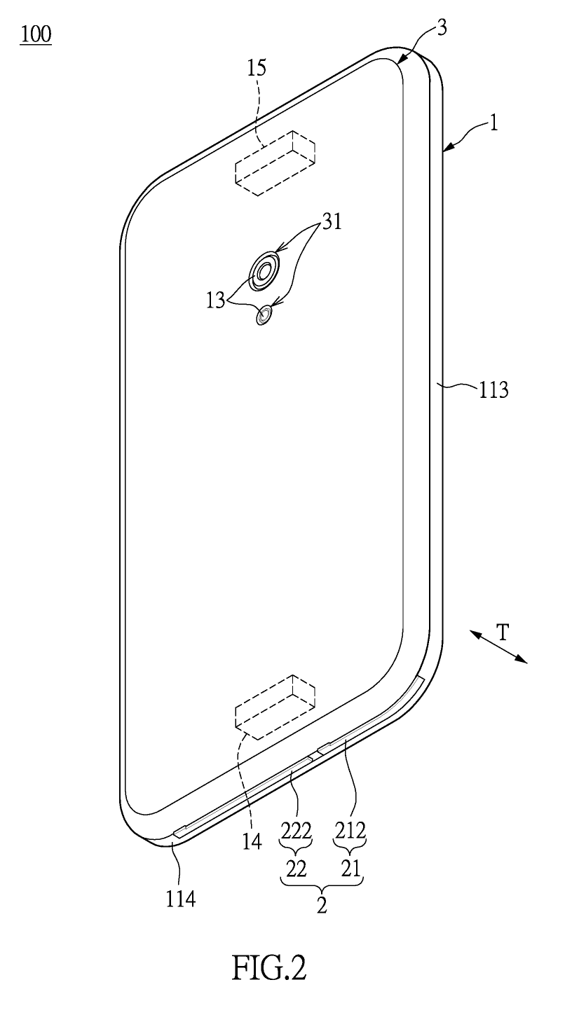

Please refer to FIGS. 1 through 4, which show an embodiment of the instant disclosure. References are hereunder made to the detailed descriptions and appended drawings in connection with the instant invention. However, the appended drawings are merely shown for exemplary purposes, rather than being used to restrict the scope of the instant invention.

As shown in FIGS. 1 through 3, the instant embodiment provides a mobile communication device 100 (i.e., smart phone). The mobile communication device 100 includes an assembly 1, an antenna module 2 disposed on the assembly 1, and a metal cover 3 detachably fixed on the assembly 1. The assembly 1 has a frame 11, a circuit board 12 mounted on the frame 11, a speaking module 14 and a listening module 15 disposed on the frame 11, and a plurality of functional components 13 installed on the circuit board 12. Moreover, the assembly 1 also includes a plurality of non-shown components, such as a display module or a battery module. The frame 11 in the instant embodiment is used to be a supporting component having a loading function, and the construction of the frame 11 is not limited to the figures of the instant embodiment.

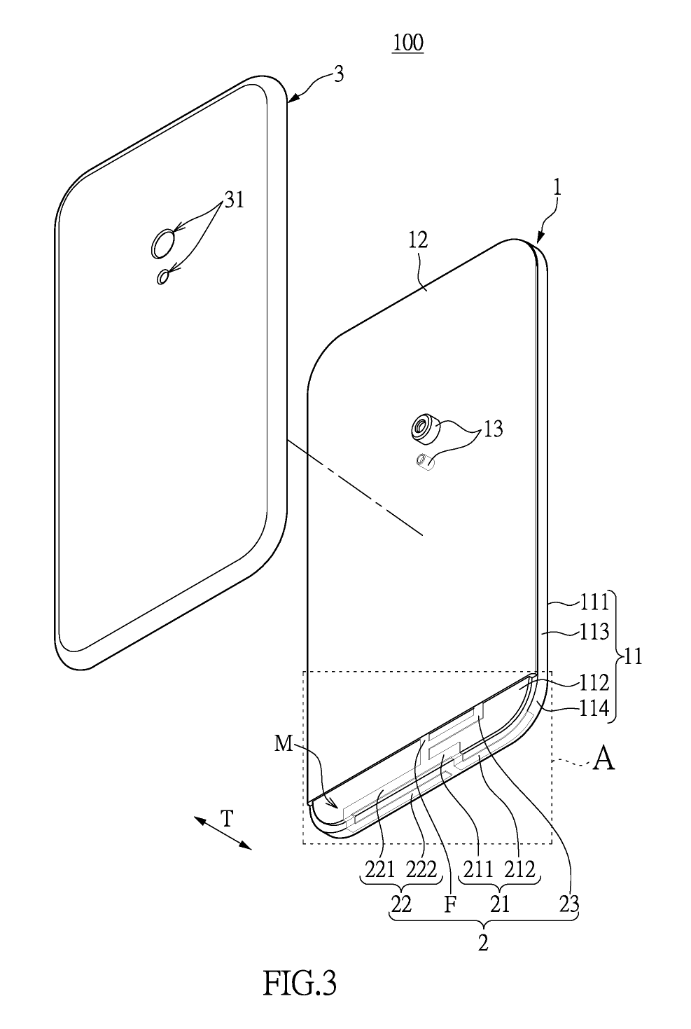

Specifically, a periphery surface of the frame 11 is approximately a rectangular shape, and the frame 11 in the instant embodiment is made of plastic material. An outer surface of the frame 11 includes a front surface 111, a rear surface 112, two long side surfaces 113 (i.e., the left side surface and the right side surface of the frame 11 shown in FIG. 3), and two short side surfaces 114 (i.e., the top side surface and the bottom side surface of the frame 11 shown in FIG. 3). The two long side surfaces 113 and the two short side surfaces 114 are perpendicularly connected to a periphery edge of the front surface 111. The frame 11 defines a thickness direction T perpendicular to the front surface 111.

The circuit board 12 is fixed on the frame 11, and the electronic components of the mobile communication device 100 are electrically connected to the circuit board 12 directly or indirectly. An outer contour of the circuit board 12 is smaller than an outer contour of the frame 11, and the rear surface 112 of the frame 11 has a mounting region M arranged between the circuit board 12 and one of the two short side surfaces 114 (i.e., the bottom short side surface 114 shown in FIG. 3). The speaking module 14 and the listening module 15 are electrically connected to the circuit board 12. The speaking module 14 and the listening module 15 are disposed on the frame 11 and are respectively arranged adjacent to the two short side surfaces 114, and the mounting region M is arranged adjacent to the speaking module 14. The functional components 13 are electrically connected to the circuit board 12, and the functional components 13 includes a connector, a camera, a flasher, and a switch, but are not limited thereto.

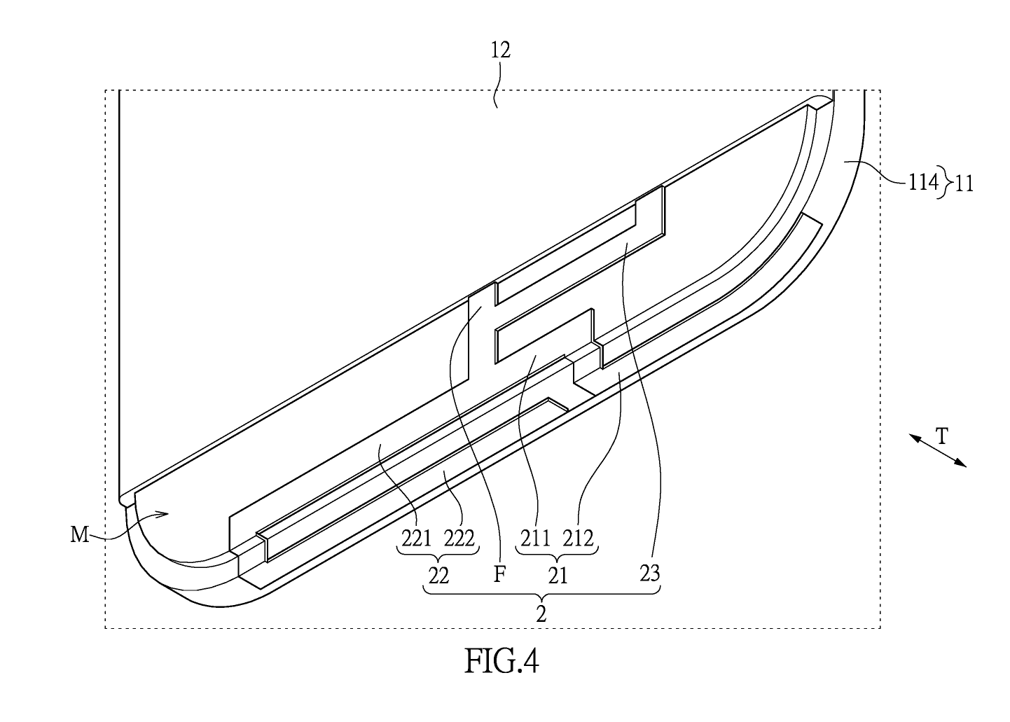

As shown in FIGS. 3 and 4, the antenna module 2 in the instant embodiment is a voice antenna module (e.g., GSM antenna module), that is to say, the antenna module 2 in the instant embodiment is not a GPS antenna module or a Wi-Fi antenna module. The antenna module 2 is disposed on the frame 11 and is electrically connected to the circuit board 12. The antenna module 2 has a high frequency antenna 21, a low frequency antenna 22, a grounding antenna 23, and a feeding segment F. The high frequency antenna 21 has a high frequency internal segment 211 and a high frequency external segment 212 integrally connected to the high frequency internal segment 211. The high frequency internal segment 211 is disposed on the mounting region M, and the high frequency external segment 212 is disposed on the short side surface 114 arranged adjacent to the mounting region M. The low frequency antenna 22 has a low frequency internal segment 221 and a low frequency external segment 222 integrally connected to the low frequency internal segment 221. The low frequency internal segment 221 is disposed on the mounting region M, and the low frequency external segment 222 is disposed on the short side surface 114 arranged adjacent to the mounting region M.

Moreover, an end of the high frequency internal segment 211, an end of the low frequency internal segment 221, and an end of the grounding antenna 23 are connected to the feeding segment F. The other end of the grounding antenna 23 is electrically connected to a grounding circuit (not shown) of the circuit board 12, and the feeding segment F is electrically connected to a signal feeding circuit (not shown) of the circuit board 12. A distance between a portion of the antenna module 2 (e.g., the feeding segment F), which is connected to the signal feeding circuit of the circuit board 12, and the adjacent short side surface 114 is preferably 3-5 mm, but is not limited thereto.

Specifically, a height of the high frequency internal segment 211 with respect to the front surface 111 of the frame 11 is greater than that of the high frequency external segment 212. The high frequency internal segment 211 is extended from the feeding segment F in a direction, which is away from the low frequency antenna 22, and the high frequency external segment 212 is extended from one end of the high frequency internal segment 211, which is arranged away from the feeding segment F, in the direction away from the low frequency antenna 22 (i.e., the low frequency external segment 222).

Moreover, a height of the low frequency internal segment 221 with respect to the front surface 111 of the frame 11 is greater than that of the low frequency external segment 222. The low frequency internal segment 221 is extended from the feeding segment F in a direction, which is away from the high frequency antenna 21, and the low frequency external segment 222 is extended from one end of the low frequency internal segment 221, which is arranged away from the feeding segment F, toward the high frequency antenna 21 (i.e., the high frequency external segment 212).

In the instant embodiment, the low frequency antenna 22 has a substantial U shape, and a total length of the low frequency external segment 222 is greater than a total length of the low frequency internal segment 221. A total length of the high frequency external segment 212 is greater than a total length of the high frequency internal segment 211. The high frequency external segment 212 and the low frequency external segment 222 in the instant embodiment are only disposed on the short side surface 114 arranged adjacent to the mounting region M (i.e., the bottom short side surface 114 shown in FIG. 3). That is to say, the high frequency external segment 212 and the low frequency external segment 222 in the instant embodiment are not disposed on the other portion of the frame 11, which excludes the bottom short side surface 114.

In addition, the construction of the antenna module 2 of the instant disclosure is not limited to the figures of the instant embodiment. In other words, if part of the antenna module 2 is disposed on the short side surface 114 of the frame 11 arranged adjacent to the mounting region M, the construction of the antenna module 2 can be adjusted according to a designer's demand. For example, the antenna module 2 of the instant disclosure can be provided without the grounding antenna 23 (not shown); the high frequency external segment 212 can be extended from the high frequency internal segment 211 toward the low frequency external segment 222 (not shown); or, the low frequency external segment 222 can be extended from the low frequency internal segment 221 in a direction, which is away from the high frequency external segment 212 (not shown).

The metal cover 3 in the instant embodiment has a plurality of mating holes 31 respectively corresponding in position to the functional components 13. The metal cover 3 is provided without any slot or hole corresponding to the antenna module 2, and the metal cover 3 is provided without any plastic material. That is to say, the metal cover 3 in the instant embodiment is preferably made only by metal material. The metal cover 3 is detachably fixed on the frame 11 of the assembly 1, and a periphery edge of the metal cover 3 aligns the two long side surfaces 113 and the two short side surfaces 114 of the frame 11, thereby the metal cover 3 entirely shields the rear surface 112 of the frame 11. Moreover, the circuit board 12 is connected to the metal cover 3, the antenna module 2 is electrically connected to the metal cover 3 by connecting the circuit board 12, and the metal cover 3 is configured to be a ground radiation portion for the antenna module 2.

Specifically, the high frequency internal segment 211 and the low frequency internal segment 221 of the antenna module 2 are arranged in a space surrounded by the metal cover 3 and the frame 11, and the high frequency internal segment 211 and the low frequency internal segment 221 are entirely shielded by the metal cover 3 in the thickness direction T. In the instant embodiment, the metal cover 3 surroundingly defines a shielding space (not shown), the high frequency internal segment 211 and the low frequency internal segment 221 of the antenna module 2 are arranged in the shielding space of the metal cover 3.

Moreover, the high frequency external segment 212 and the low frequency external segment 222 of the antenna module 2 are arranged outside the space surrounded by the metal cover 3 and the frame 11. That is to say, the high frequency external segment 212 and the low frequency external segment 222 in the instant embodiment are arranged outside the shielding space of the metal cover 3. The high frequency external segment 212 and the low frequency external segment 222 do not contact the metal cover 3 and are provided for receiving and emitting signals. Additionally, the figures of the instant embodiment show the high frequency external segment 212 and the low frequency external segment 222 visibly formed on the short side surface 114 of the frame 11, but the frame 11 can be modified to hide the high frequency external segment 212 and the low frequency external segment 222.

Based on the above description, the metal cover 3 is provided without any slot or hole related to the antenna module 2. The high frequency internal segment 211 and the low frequency internal segment 221 are entirely shielded by the metal cover 3, but the high frequency external segment 212 and the low frequency external segment 222 can be used to receive and emit signals, thus the antenna module 2 can be normally operated. Specifically, the antenna module 2 is configured to be used in a low frequency band of 820-960 MHz and a high frequency band of 1700-2700 MHz, and the antenna module 2 has an antenna effect of at least −6 dB in the low frequency band and an antenna effect of at least −5 dB in the high frequency band, so the antenna module 2 of the instant embodiment achieves the conventional standard.

### THE POSSIBLE EFFECT OF THE INSTANT DISCLOSURE

In summary, the mobile communication device of the instant embodiment is provided with the high frequency external segment and the low frequency external segment, which are disposed on the short side surface, for receiving or emitting signals, thus the antenna module can be normally operated and the metal cover can be provided without any slot or hole related to the antenna module.

Moreover, the antenna module of the mobile communication device is preferably a voice antenna module arranged adjacent to the speaking module, and the antenna module is electrically connected to the metal cover by connecting the circuit board, thus the metal cover is configured to be the ground radiation portion for the antenna module.

The descriptions illustrated supra set forth simply the preferred embodiments of the instant invention; however, the characteristics of the instant invention are by no means restricted thereto. All changes, alterations, or modifications conveniently considered by those skilled in the art are deemed to be encompassed within the scope of the instant invention delineated by the following claims.

What is claimed is:

1. A mobile communication device, comprising:
an assembly, comprising:
a frame having a front surface, a rear surface, two long side surfaces, and two short side surfaces, wherein the two long side surfaces and the two short side surfaces are connected to a peripheral edge of the front surface, the frame defines a thickness direction perpendicular to the front surface; and
a circuit board disposed on the frame, wherein the frame has a mounting region arranged between the circuit board and one of the two short side surfaces;
an antenna module disposed on the frame and electrically connected to the circuit board, the antenna module comprising:
a high frequency antenna having a high frequency internal segment and a high frequency external segment connected to the high frequency internal segment, wherein the high frequency internal segment is disposed on the mounting region, and the high frequency external segment is disposed on the one of the short side surfaces arranged adjacent to the mounting region; and
a low frequency antenna having a low frequency internal segment and a low frequency external segment connected to the low frequency internal segment, wherein the low frequency internal segment is disposed on the mounting region, and the low frequency external segment is disposed on the one of the short side surfaces arranged adjacent to the mounting region; and
a metal cover detachably fixed on the frame of the assembly, wherein the high frequency internal segment and the low frequency internal segment of the antenna module are arranged in a space surrounded by the metal cover and the frame, the high frequency internal segment and the low frequency internal segment are shielded by the metal cover in the thickness direction, the high frequency external segment and the low frequency external segment of the antenna module are arranged outside the space surrounded by the metal cover and the frame, and the high frequency external segment and the low frequency external segment do not contact the metal cover.

2. The mobile communication device as claimed in claim 1, wherein the high frequency external segment is extended from the high frequency internal segment in a direction away from the low frequency external segment, the low frequency external segment is extended from the low frequency internal segment toward the high frequency external segment.

3. The mobile communication device as claimed in claim 2, wherein a total length of the high frequency external segment is greater than a total length of the high frequency internal segment, and the high frequency external segment and the low frequency external segment are only disposed on the one of the short side surfaces arranged adjacent to the mounting region.

4. The mobile communication device as claimed in claim 3, wherein the antenna module is a voice antenna module, the assembly has a speaking module and a listening module, the speaking module and the listening module are disposed on the frame and are respectively arranged adjacent to the two short side surfaces, the mounting region is arranged adjacent to the speaking module.

5. The mobile communication device as claimed in claim 1, wherein the antenna module is configured to be used in a low frequency band of 820-960 MHz and a high frequency band of 1700-2700 MHz, and wherein the antenna module has an antenna effect of at least −6 dB in the low frequency band and an antenna effect of at least −5 dB in the high frequency band.

6. The mobile communication device as claimed in claim 1, wherein the metal cover is provided without any plastic material, and the metal cover is provided without any slot or hole corresponding to the antenna module.

7. The mobile communication device as claimed in claim 6, wherein the circuit board is connected to the metal cover, the antenna module is electrically connected to the metal cover by connecting the circuit board, and the metal cover is configured to be a ground radiation portion for the antenna module.

8. The mobile communication device as claimed in claim 7, wherein the antenna module has a grounding antenna and a feeding segment, an end of the high frequency internal segment, an end of the low frequency internal segment, and an end of the grounding antenna are connected to the feeding segment, the other end of the grounding antenna is electrically connected to a grounding circuit of the circuit board, and the feeding segment is electrically connected to a signal feeding circuit of the circuit board.

9. The mobile communication device as claimed in claim 1, wherein the metal cover surroundingly defines a shielding space, the high frequency internal segment and the low frequency internal segment of the antenna module are arranged in the shielding space of the metal cover.

10. A mobile communication device, comprising:
an assembly, comprising
a frame having a front surface, a rear surface, two long side surfaces, and two short side surfaces, wherein the two long side surfaces and the two short side surfaces are connected to a peripheral edge of the front surface, the frame defines a thickness direction perpendicular to the front surface; and
a circuit board disposed on the frame, wherein the frame has a mounting region arranged between the circuit board and one of the two short side surfaces; and
an antenna module disposed on the frame and electrically connected to the circuit board, the antenna module comprising:
a high frequency antenna having a high frequency internal segment and a high frequency external segment connected to the high frequency internal segment, wherein the high frequency internal segment is disposed on the mounting region, and the high frequency external segment is disposed on the one of the short side surfaces arranged adjacent to the mounting region; and
a low frequency antenna having a low frequency internal segment and a low frequency external segment connected to the low frequency internal segment, wherein the low frequency internal segment is disposed on the mounting region, and the low frequency external segment is disposed on the one of the short side surfaces arranged adjacent to the mounting region.
